(19) United States
(12) Patent Application Publication
(10) Pub. No.: US 2022/0266678 A1
(43) Pub. Date: Aug. 25, 2022

(54) ELECTRIC HUB DRIVE WITH BRAKING ASSEMBLY

(71) Applicant: QINETIQ LIMITED, Farnborough Hampshire (GB)

(72) Inventor: Robert William THOMPSON, Camberley (GB)

(21) Appl. No.: 17/734,433

(22) Filed: May 2, 2022

Related U.S. Application Data
(63) Continuation-in-part of application No. 15/557,719, filed on Sep. 12, 2017.

(30) Foreign Application Priority Data
Mar. 17, 2015 (GB) 1504447.2

(51) Int. Cl. B60K 7/00; B60K 17/04

(52) U.S. Cl. CPC B60K 7/0007; B60K 17/043; B60K 2007/0038

(57) ABSTRACT

Some embodiments are directed to an electric hub drive with a braking assembly. The hub drive includes a housing; a rotary drive transmission system mounted within the housing; and a braking assembly positioned within the housing. The braking assembly includes a braking formation that is coupled to be rotationally driven by the rotary drive transmission system. Advantageously or preferably, the braking formation is coupled to be rotationally driven by a part of the rotary drive transmission system that has a higher angular velocity than the output shaft. This enables the braking formation to rotate at a faster speed than the wheel hub.

### CROSS REFERENCE TO RELATED APPLICATION(S)

This application is a continuation-in-part application of and claims priority under 35 U.S.C. 120 to U.S. patent application Ser. No. 15/557,719 filed on Sep. 12, 2017, which is a national phase filing under 35 C.F.R. § 371 of and claims priority to PCT Patent Application No. PCT/EP2016/055539, filed on Mar. 15, 2016, which claims the priority benefit under 35 U.S.C. § 119 of British Patent Application No. 1504447.2, filed on Mar. 17, 2015, the contents of each of which are hereby incorporated in their entireties by reference.

### BACKGROUND

Some embodiments relate to an electric hub drive with a braking assembly, in particular, an electric hub drive including a hub drive housing, with a braking assembly contained within the housing.

Electric drive wheel hubs are used in situations where it is advantageous for vehicle wheels to be driven independently, for example, where the vehicle is large or used on uneven terrain. The wheel hub typically includes a housing containing an electric rotor, and a drivetrain including a drive shaft and a gearing mechanism, with the components arranged inside the housing to ensure the overall assembly is water tight. This allows the assembly to be used on a wide variety of terrains and in various weather conditions.

### SUMMARY

A braking mechanism is provided to retard the wheel. The braking mechanism is for example formed from a brake disc and caliper of a size to ensure that the torque generated by braking such a large vehicle at various speeds is dealt with appropriately. For example, a vented or air-cooled brake disc may be used in conjunction with a caliper to create the necessary energy absorption. However, since the overall drive assembly is mounted on the individual wheel rather than centrally on the vehicle, the entire assembly is limited in size to the wheel rim diameter, in other words, the diameter of the inner volume of the wheel itself. Practically, in large-wheeled vehicles having wheels with rim diameters of over 25 inches (approximately 635 mm), it is relatively easy to provide a brake disc and caliper assembly that provides sufficient braking under a wide range of conditions, since this sits easily in the radial space between the hub drive and the rim of the wheel. However, issues arise when smaller diameter wheels, those with rims of less than 21 inches (approximately 533 mm) in diameter, as it can be difficult to house either a sufficient diameter brake disc or multiple smaller brake discs within the space provided by the inner volume of the wheel. Although brake discs with smaller diameters can be coupled together to use with a particular caliper, and this forms a practical solution for some wheel hubs, this is not always desirable as there is only limited space laterally within the wheel due to the other components of the hub drive. The overall lateral dimension is therefore limited by the useful size of the tyre and the space available for a wheel hub to either sit underneath a vehicle or project outwards from a vehicle in use.

Some embodiments address these problems by providing an electric hub drive including: a housing; a rotary drive transmission system including an input shaft, and output shaft, and a torque transfer arrangement to effect a rotational coupling between the input shaft and the output shaft mounted within the housing; and a braking assembly including a braking formation positioned within the housing; wherein the braking formation is coupled to be rotationally driven by the drive transmission system.

Mounting the braking formation within the housing removes the need to position any form of braking mechanism radially within space between any housing and the inner surface of a wheel rim as done in existing vehicles. This results in being able to position components optimally in reduced volumes created by using smaller diameter wheel rims in a wider variety of vehicles.

In accordance with some embodiments, the braking formation is mounted within the housing and coupled to be rotationally driven by a suitable part of the drive transmission system. Advantageously or preferably, the braking formation is coupled to be rotationally driven at an angular velocity equal to or greater than that of the output shaft of the hub drive and most advantageously or preferably greater than that of the output shaft of the hub drive.

Conventionally, the input shaft of an electric hub drive is driven by a suitable electric drive mechanism, the output shaft of an electric hub drive is configured to drive the wheel, and the driven input shaft angular velocity is reduced to the driving output shaft angular velocity by a drive transmission system including a gearing assembly. In such a case the braking formation is preferably coupled to be rotationally driven at an angular velocity greater than that of the output shaft of the hub drive by mechanism of a torque coupling to a part of the gearing assembly having an angular velocity greater than that of the output shaft and for example forward of at least a final gearing reduction. For example, the gearing assembly includes a final reduction gear the output of which reduction gear drives the hub output shaft, and the braking formation has a torque coupling to an input of the reduction gear.

Advantageously or preferably, the braking formation is carried on a drive shaft coupled to be driven rotationally by the drive transmission system. The braking formation is coupled rotationally to the drive shaft but may be free to move axially relative to the drive shaft.

Advantageously or preferably, the braking formation is a friction formation selectively engageable against one or more complementary friction surfaces carried within the housing.

Advantageously or preferably, the braking formation includes one or more brake discs. The brake disc or discs may be mounted co-axially on a drive shaft coupled to be driven rotationally by the drive transmission system.

Advantageously or preferably, the friction surface(s) include the surfaces of one or more brake pads carried within the housing, and for example mounted in a rotationally static relationship to the housing. Thus, preferably, the braking assembly further includes a plurality of brake pads mounted within the housing and adapted to contact the braking formation.

In a possible embodiment, a plurality of friction surfaces, for example including a plurality of brake pads, are provided on one or more carrier formations. The carrier formation is for example a carrier disc. The pads may be disposed across the surface of the carrier disc.

A carrier formation such as a carrier disc may be provided on either side of the brake disc, so as to engage a respective surface of the brake disc and effect a braking action. In cases where more than one disc is provided in axial array a carrier formation such as a carrier disc with brake pads or other friction surfaces on both sides may be placed between discs.

Advantageously or preferably, the braking assembly further includes an actuation mechanism to effect selective engagement and disengagement of the braking formation against the friction surface(s). In a possible embodiment the actuation mechanism is operable to move the braking formation into and out of engagement with the friction surface(s). In an alternative embodiment the friction surface(s) are carried on a carrier formation and the actuation mechanism is operable to move the carrier formation and thereby bring the friction surface(s) into and out of engagement with the braking formation.

In a possible embodiment an actuation mechanism includes a ball ramp mechanism or a hydraulic cylinder or cylinders or a pneumatic actuator.

Advantageously or preferably, the hub drive has an inboard side for positioning proximal to a vehicle and an outboard side for positioning distal to a vehicle, and the brake disc is positioned on the inboard side of the hub drive.

Advantageously or preferably, the hub drive further includes an electric drive mechanism coupled to drive the input shaft, and for example an electric motor having a motor rotor for driving the hub drive input shaft mounted within the housing, the motor rotor for example being positioned co-axially around the hub drive input shaft.

Advantageously or preferably, the hub drive further includes a gearing assembly mounted within the housing, the gearing assembly being positioned axially with respect to the input shaft.

Advantageously or preferably, the hub drive output shaft is coupled to be driven by an output side of the gearing system, and for example coupled to be driven by an output shaft of an output reduction gear.

Advantageously or preferably, the brake disc, the rotor and the gearing assembly are arranged axially with each other.

Advantageously or preferably, the motor rotor is interposed between the brake disc and the gearing assembly.

Advantageously or preferably, the housing is adapted to fit within the axial width of a wheel rim of a wheel to be driven by the hub drive.

Advantageously or preferably, the housing is cooled.

### BRIEF DESCRIPTION OF THE DRAWINGS

Some embodiments will now be described by way of example only, and with reference to the accompanying drawings, in which:

FIG. 1 is a schematic cross-section of an electric wheel hub braking system in accordance with some embodiments; and

FIG. 2 is an exploded view of a brake disc and pads suitable for use with a braking system in accordance with some embodiments.

### DETAILED DESCRIPTION OF THE EMBODIMENTS

In some embodiments, it has been appreciated that it is not necessary to position a brake disc within the radial space between the inner surface of a wheel rim and a hub drive in order to provide sufficient braking at even high torques. In accordance with some embodiments, an electric hub drive 4 includes a housing 5, a rotary drive transmission system including an input shaft 6, and output shaft 13, and a torque transfer arrangement to effect a rotational coupling between the input shaft 6 and the output shaft 13 mounted within the housing, and a braking assembly, and a drive shaft 8 (can also be referred to as the brake shaft) in accordance with the principles of some embodiments positioned within the housing. The braking mechanism is driven by a torque coupling to the drive transmission system, and in a particular preferred case to a part of the transmission system that has the same or a greater angular velocity than the output shaft 13 that drives the wheel such that it rotates faster than or at the same speed as the wheel during braking. Torque coupling can refer to rotary mechanical communication between two elements. The torque transfer arrangement can include a gearing assembly configured to reduce a higher input shaft 6 angular velocity to a lower output shaft 13 angular velocity, the gearing assembly can include a selectively engageable gear set 10 and a reduction gear 11 which drives the output shaft 13 of the hub drive. The selectively engageable gear set 10 can also be referred to as the gear change set or the selectively engageable gear change set. The reduction gear 11 can also be referred to as the fixed ratio output reduction gear or the final reduction gear. Collectively, the gear change set 10 and the final reduction gear 11 can also be referred to as gearing assemblies 10, 11.

The input shaft 6 can be disposed between an electric motor 9 and the gear change set 10. The input shaft 6 can be separate from the drive shaft 8. The drive shaft 8 can extend between the fixed ratio output gear 11 and a brake disk 7. The drive shaft 8 can be connected to an input of the fixed ratio output reduction gear 11 at a first end and connected to the brake disk 7 at a second end.

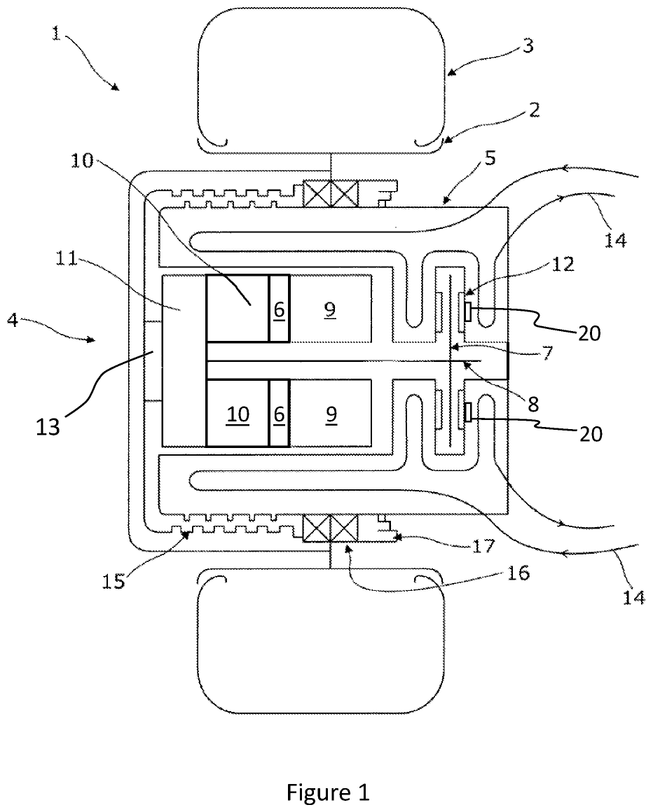

FIG. 1 is a schematic cross-section of an electric hub drive system including an electric hub drive incorporating a braking system in accordance with some embodiments. An electric hub drive system 1 includes the electric hub drive 4 to drive a wheel including a wheel rim 2 on a wheel bearing 16 sealed by seal 17, the wheel rim generally having the form of an open cylinder, with an inner surface and an outer surface with a tire 3 mounted radially on the outer surface of the wheel rim 2 for contact with the terrain on which a vehicle (not shown) carrying the wheel hub will drive over.

The volume described by the inner surface of the open cylinder of the wheel rim 2 contains the electric hub drive 4. The electric hub drive 4 includes the housing 5 for example of aluminium, containing an electric drive mechanism, a braking assembly, and a drive transmission system including gearing assembly to transmit drive from the electric drive mechanism to the driven wheel. The housing 5 can include a gearbox casing and the motor housing.

The electric drive mechanism includes the electric motor 9 which can be a rotary electric motor mounted within the housing 5. The motor 9 is positioned co-axially around the drive shaft 8. A gearing system in the embodiment includes the selectively engageable gear change set 10 and the fixed ratio output reduction gear 11. The selectively engageable gear change set 10 can be a gearbox having a plurality of ratios and/or speeds which are user selectable. An example of a selectively engageable gear change set 10 can include, but is not limited to, a set of user selectable gears. A gear change set can refer to a multi ratio and/or multi speed gearbox. Selectively engageable can refer to multiple gears within a set that are engageable with each other to provide a plurality of different gear ratios and/or speeds. The selectively engageable gear change set 10 can also be referred to as the gearbox. The selectively engageable gear change set 10 can be rotationally coupled to the final reduction gear 11 through the drive shaft 8. The gear change set 10 can be connected to the electric motor 9 optionally via a clutch not shown. An oil cooler system 15 can cool the gearbox 10.

The braking assembly includes the drive shaft 8 mounted within the housing 5, and a braking formation 7, mounted on the shaft 8, such that the braking formation 7 is rotatably driven by the drive shaft 8. In this embodiment the braking formation 7 can be a brake disc, which is mounted co-axially on the drive shaft 8. In other words, the drive shaft 8 passes through the centre of the brake disc 7.

The gearing assemblies 10, 11 are positioned axially with respect to the shaft 8. This ensures that the brake disc 7, the electric motor 9 and the gearing assemblies 10, 11 are arranged axially with each other and the shaft 8. This arrangement is enhanced or optimised to fit all the required components for the hub drive within both the radial space allowed by the wheel rim 2 and the transverse space available to the hub assembly for practical use on a vehicle.

The electric hub drive 4 has an inboard side for positioning proximal to a vehicle and an outboard side for positioning distal to a vehicle. It can be advantageous to position the brake disc 7 on the inboard side of the assembly. This is advantageous because this can be the side with the stationary casing for connection to the suspension system and to which brake pad assemblies 22, 24 can be mounted. The outer part of the casing rotates with the wheel.

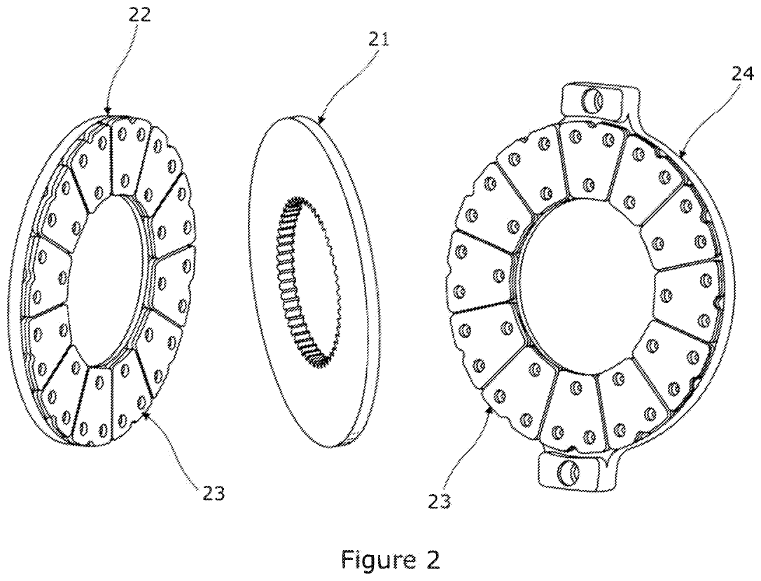

In order to apply sufficient braking by friction with the brake disc 7, a plurality of brake pads 12 are mounted within the housing 5 on cooled discs and adapted to contact the brake disc 7. The arrangement is shown in greater detail in FIG. 2.

It can be advantageous that the drive shaft 8 is torque coupled to a part of the drive transmission system that is rotating at higher speed than the speed output to the wheels. In the embodiment, the drive shaft 8 is torque coupled to the input side of the output reduction gear 11. The input side of the reduction gear has a higher angular velocity than the output side driving the wheels. Thus, the brake disc rotates at a faster speed than the wheels. Typically, the input side of the reduction gear can run four times faster than the output side and hence than the wheel, such that the torque capacity of the brake is four times lower than it would be if it were braking the wheel directly. The size of the brake disc 7, the brake pads 12, and the force required to operate the brake are reduced proportionally allowing for a reduction in size and mass compared with existing braking assemblies.

As shown in FIG. 1, the housing 5 is adapted to fit within the wheel rim 2. The housing 5 may be cooled using a cooling mechanism 14, which may be, for example, a water cooling mechanism. The use of water cooling instead of air cooling allows the system to be sealed to prevent ingress of dirt. In embodiments that include the housing 5 cooled by a water-cooled cooling mechanism 14, the housing 5 can be watertight, sealed, or closed through any method known in the art for containing a water cooling system within the housing while preventing external fluid from entering. The water cooled hub structure cools the brake pads, as well as the motor housing 5 and the gearbox casing. The gearbox casing can refer to a cavity in the water cooled hub structure containing the gearing system (which comprises the selectively engageable gear change set 10 and the fixed ratio output reduction gear 11—collectively the gearing assemblies). The gear box is cooled and lubricated by a fixed volume of oil contained inside the hub. This oil fills the gap between the cooled structure supporting the gearbox 10 and the rotating outer casing. A narrow gap is provided with heat transfer features so that the shearing action of the oil in the gap aids heat transfer—heat transfer from static oil is otherwise poor.

The brake disc 7 can be rotationally coupled to the drive shaft 8 but is free to move axially, and may be mounted on splines, axial pins, a key way or other connection mechanism to effect this.

The brake disc 7 may be a metal brake disc, such as a steel brake disc, or a composite material, such as a carbon fibre brake disc. The brake disc 7 may be closed or vented, and may be cooled. As noted, a closed water cooled system can allow the housing 5 to be completely sealed from the ingress of external elements such as water, dust, mud and dirt.

The brake pads 12 may be formed from materials having ideal frictional relationships with the brake disc material, such as sintered metallic materials or bonded organic materials.

FIG. 2 illustrates an embodiment of disc brake assembly with brake components disassembled.

A brake disc 21 is provided to be mounted on and rotated with the drive shaft 8, and can have an angular velocity that is greater than that of the hub output shaft 13, and for example by coupling to the input of the final reduction gear 11 as described with reference to FIG. 1. The brake disc can be annular and provided on the inside with splines whereby it rotates with the shaft but floats axially.

Paired brake pad assemblies 22, 24 are provided at either side of the brake disc 21. An inner brake pad assembly 22 is fixed in the hub case and includes a carrier disc that carries a plurality of brake pads 23 covering essentially its entire surface. The brake pad assembly can be water cooled. An outer brake pad assembly 24 including a carrier disc again covered essentially on its entire surface by a plurality of brake pads 23, is mounted within the hub case to be moveable axially by a brake actuator 20. The outer brake pad assembly is again water cooled.

Under action of the brake actuator 20, engagement is effected between the brake disc and the paired brake pad assemblies 22, 24, effecting retardation of the brake disc, and hence of the shaft 8, and hence because the shaft 8 is torque coupled to the hub drive transmission and for example to the input shaft of the output reduction gear 11, effects braking of the hub drive and of the wheel.

Although in the embodiment a single brake disc is used, a possible configuration, for example for a higher capacity brake, might be to have a plurality of discs stacked axially. In such an arrangement a carrier disc that carries a plurality of brake pads on each of its opposed faces may then be provided between each adjacent pair of discs in the stacked array.

The hub drive may be adapted for regenerative braking.

Although in the embodiment shown in FIG. 1 it is advantageous to position the braking mechanism on the inboard side of the hub drive with the gearing assembly 10, 11 on the outboard side and the electric motor 9 positioned centrally, it is possible to arrange the components differently whilst still maintaining their axial arrangement and thus taking advantage of the main benefits of some embodiments. For example, the braking mechanism may be positioned on the outboard side, or centrally.

In other embodiments, the selectively engageable gear change set can be any conventional multi-ratio/multi-speed gearbox including for example spur gears, helical gears, bevel gears, epicyclic/planetary gears, or any other type of gear known to one of ordinary skill in the art.

The specific configuration of the selectively engageable gear change set 10 does not characterise the presently disclosed subject matter. Rather, the presently disclosed subject matter lies, at least in part, in the realisation that using a conventional selectively engageable gear change set (gearbox) 10 can require some form of disconnectable torque coupling (e.g. clutch) between the motor 9 and the gear change set 10 to enable different ratios/speeds to be selected.

An inherent limitation that can occur of such a disconnectable coupling is loss of retardation/braking of the wheel hub via the input shaft 6 when the couple is disconnected (clutch is open).

In order to solve this potential limitation, the braking assembly can be coupled to the drivetrain “downstream” of the selectively engageable gear change set, e.g. to the input of the final (fixed ratio) drive assembly. In such a configuration, the brake assembly is unaffected by opening the disconnectable torque coupling/clutch “upstream” thereof and ensures braking can always be available to the wheel hub via the final drive assembly.

Alternative embodiments can include a selectively engageable gear change set that can include a clutch mechanism having rotatable plates or dogs which can be selectively separate and engaged to disconnect or connect drive between the prime mover (engine or electric motor) of a vehicle and the gearbox and drive train.

In an alternative embodiment including a dog clutch mechanism in a hub drive, a selectively engageable gear change set can include two planetary gears arranged in a series configuration, where each of the two gear ratios are respectively selectable by a dog clutch/hub configuration. During shift between gear ratios when the dog clutch is open and the vehicle wheel rim 2 is disengaged from the electric drive motor, having the braking assembly coupled to the input of a final reduction gear 11 ensures braking effect is maintained even when the dog clutch is open/disengaged (thereby removing any retarding effect of the electric motor).

These and other advantages of some embodiments will be apparent from the appended claims.

What is claimed is:

1. An electric hub drive comprising:
a housing;
a rotary drive transmission system including an input shaft, an output shaft, and a torque transfer arrangement to effect a rotational coupling between the input shaft and the output shaft mounted within the housing;
an electric motor having a motor rotor for driving the input shaft mounted within the housing; and
a braking assembly including a braking formation positioned within the housing,
the braking formation is configured to be coupled to be rotationally driven by the drive transmission system.

2. The hub drive of claim 1 wherein the braking formation is carried on a drive shaft coupled to be driven rotationally by the drive transmission system.

3. The hub drive of claim 1, wherein the braking formation is a friction formation selectively engageable against one or more complementary friction surfaces carried within the housing.

4. The hub drive of claim 1, wherein the braking formation includes at least one brake disc.

5. The hub drive of claim 4, wherein at least one brake disc is mounted co-axially on a shaft coupled to be driven rotationally by the drive transmission system.

6. The hub drive of claim 1, wherein the braking formation is coupled to be rotationally driven at an angular velocity equal to or greater than that of the output shaft of the hub drive.

7. The hub drive of claim 6, wherein the braking formation is coupled to be rotationally driven at an angular velocity greater than that of the output shaft of the hub drive

8. The hub drive of claim 7, wherein the rotary drive transmission system includes a gearing assembly configured to reduce a higher input shaft angular velocity to a lower output shaft angular velocity and the braking formation is coupled to be rotationally driven by a part of the gearing assembly having an angular velocity greater than that of the output shaft.

9. The hub drive of claim 8, wherein the gearing assembly includes a final reduction gear the output of which reduction gear drives the output shaft of the hub drive, and the braking formation has a torque coupling to an input of the final reduction gear.

10. The hub drive of claim 3, wherein the friction surface(s) comprise the surfaces of one or more brake pads carried within the housing.

11. The hub drive of claim 10, wherein a plurality of brake pads are provided on one or more carrier formations.

12. The hub drive of claim 11, wherein the plurality of brake pads are provided disposed across the surface of each of one or more carrier formations in the form of carrier discs.

13. The hub drive of claim 12, wherein the braking formation includes at least one brake disc, and wherein a pair of the carrier discs are provided, one disposed on either side of the brake disc, so as to engage a respective surface of the brake disc and effect a braking action in use.

14. The hub drive of claim 3, wherein the braking assembly further comprises an actuation means to effect selective engagement and disengagement of the braking formation against the friction surface(s).

15. The hub drive of claim 1, wherein the hub drive has an inboard side for positioning proximal to a vehicle and an outboard side for positioning distal to a vehicle, and the braking formation is positioned on the inboard side.

16. The hub drive of claim 1, further comprising a brake shaft connecting a brake disc to an input of a fixed ratio reduction output gear, the brake shaft separate from the motor and extending through the motor.

17. The hub drive of claim 1, further comprising a gearing assembly wherein the motor rotor is interposed between the braking formation and the gearing assembly.

18. The hub drive of claim 1, wherein the housing is adapted to fit within the wheel rim of a wheel.

19. The hub drive of claim 1, wherein the housing is cooled.

20. An electric hub drive comprising:
a housing;
a rotary drive transmission system including an input shaft, an output shaft, and a torque transfer arrangement to effect a rotational coupling between the input shaft and the output shaft mounted within the housing;
an electric motor having a motor rotor for driving the hub drive input shaft mounted within the housing;
a braking assembly including a braking formation positioned within the housing, the braking formation being coupled to be rotationally drive by the drive transmission system;
wherein the torque transfer arrangement includes a gearing assembly configured to reduce a higher input shaft angular velocity to a lower output shaft angular velocity, the gearing assembly including a selectively engageable gear change set rotationally coupled to a final reduction gear having an output which drives the output shaft of the hub drive, and the braking formation is coupled to be rotationally driven by a part of the gearing assembly having an angular velocity greater than that of the output shaft,
wherein the motor rotor is interposed between the braking formation and the gearing assembly, and
the braking formation has a torque coupling to an input of the final reduction gear.
